(19) United States
(12) Patent Application Publication
(10) Pub. No.: US 2008/0298577 A1
(43) Pub. Date: Dec. 4, 2008

(54) METHOD AND SYSTEM FOR PROCESSING COMMUNICATION SIGNALS IN A COMMUNICATION SYSTEM

(75) Inventors: Poul Kristian MOHL, Kobenhavn S (DK); Bo Bonnichsen, Veksoe Sjaelland (DK); Peter Theilgaard Hounum, Aalborg (DK)

Correspondence Address: BINGHAM MCCUTCHEN LLP, Three Embarcadero Center, San Francisco, CA, 94111-4067, US

(73) Assignee: GN Netcom A/S, Ballerup (DK)

(21) Appl. No.: 12/114,250

(22) Filed: May 2, 2008

Related U.S. Application Data
(60) Provisional application No. 60/915,496, filed on May 2, 2007.

(51) Int. Cl. H04M 1/00

(52) U.S. Cl. 379/391

(57) ABSTRACT

Disclosed are a method and an apparatus for processing communication signals in a telephony or communication system. In various embodiments, the method or the apparatus comprises identifying a first signal which comprises an incoming communication signal and a feedback signal, controlling a logic for cancelling or suppressing a feedback effect based at least in part upon the first signal, processing the first signal using an adaptive filter based at least in part upon the first signal and a result of controlling the logic for cancelling or suppressing the feedback effect, and causing the processed first signal to be transmitted to a first output device. In some embodiments, the method and the apparatus further comprise identifying a communication context which the communication system is currently in. In some embodiments, the method and apparatus further comprise determining a filter coefficient for the adaptive filter.

### RELATED APPLICATIONS

This application claims the benefit of the U.S. provisional application under the Ser. No. 60/915,496 which was filed on 2 May 2007, the disclosure of which is expressly incorporated by reference in their entirety herein.

### FIELD

The application relates to a method or a system for processing communication signals in a communication or telephony system.

### BACKGROUND

It is known in telephony that a sidetone is produced in the use of communication equipment, such as wired or wireless telephones or wireless telegraphy or radio, which provides voice communication over distance. Sidetone is the effect of sound or acoustic signals which are picked up by the input device (e.g., a microphone or a mouthpiece of a telephone) and then introduced, sometimes at an attenuated or lower level, back into the output device (e.g., a earpiece, headset, or loudspeaker) of the equipment. Sidetone effectively acts as a feedback of the signals applied to the output signals of the communication device or equipment. Sidetone effect enables the user or operator of the communication device or equipment to hear his or her own voice, in the case of voice communication, or signals which are intended to be transmitted in the case of radiotelegraphy or radio. That is, without sidetone, users do not hear their own voice in the output device, and operators of radiotelegraphy or radio equipment do not get the feedback from the signals they intended to transmit.

Nonetheless, too much sidetone causes the users or operators to hear this feedback too loudly and therefore may cause some discomfort. Moreover, sidetone, if not processed properly, may also cause audio feedback in teleconferencing as sidetone effectively creates a sound loop between the input and the output devices of the communication device or equipment. Moreover, when a user uses a wireless output device such as a wireless headset or handset, the delay in the wireless transmission between the base station and the headset or handset of the communication device may cause the sidetone signals to be experienced as an echo rather than a direct feedback of the input signal. In signal processing and acoustics, an echo constitutes a reflection of the sound signals at the listener end some time after the direct sound signal. Where there are so many reflections arriving at the listener such that the user is unable to distinguish one reflection from another, these reflections effective cause reverberation which refers to the persistence of sound in a space after the original sound signal is removed.

Therefore, there exists a need for implementing a method or a system for properly processing sidetone by utilizing a sidetone echo canceller (SEC) or a sidetone echo suppressor (SES) for a communication or telecommunication device or equipment.

### SUMMARY

In various embodiments, the method or the apparatus for processing communication signals in a communication or telephony system identifies a first signal, in which the first signal comprises an incoming communication signal and a feedback signal. In various embodiments, the method or the apparatus controls a logic for cancelling or suppressing a feedback effect based at least in part upon the first signal. In various embodiments, the method or the apparatus processes the first signal using an adaptive filter based at least in part upon the first signal and a result of the act of controlling the logic for cancelling or suppressing the feedback effect. In various embodiments, the method or the apparatus causes the processed first signal to be transmitted to a first output device. In some embodiments, the method or the apparatus further identifies a communication context which the communication system or the telephony system is in. In some embodiments, the method or the apparatus further receives a reference signal from a first input device.

It shall be noted that the preceding and the following passages of the specification and the drawings may use some examples in certain field(s) of endeavour. Nonetheless, these examples or field(s) of endeavour are presented for illustration and ease of explanation and do not intend to limit the scope.

Various embodiments will now be described in further detail with reference to the accompanying drawings.

### BRIEF DESCRIPTION OF THE EMBODIMENTS

The accompanying drawings are included to provide a further understanding of the disclosure herein and, together with the Detailed Description, serve to explain the principles of various embodiments disclosed herein. Moreover, the drawings illustrate the design and utility of various embodiments. It should be noted that the figures are not drawn to scale and that elements of similar structures or functions are represented by like reference numerals throughout the figures. In order to better appreciate how the above-recited and other advantages and objects of various embodiments are obtained, a more particular description of various embodiments briefly described above will be rendered by reference to specific embodiments thereof, which are illustrated in the accompanying drawings. Understanding that these drawings depict only exemplary embodiments and are not therefore to be considered limiting of its scope, various embodiments will be described and explained with additional specificity and details through the use of the accompanying drawings in which:

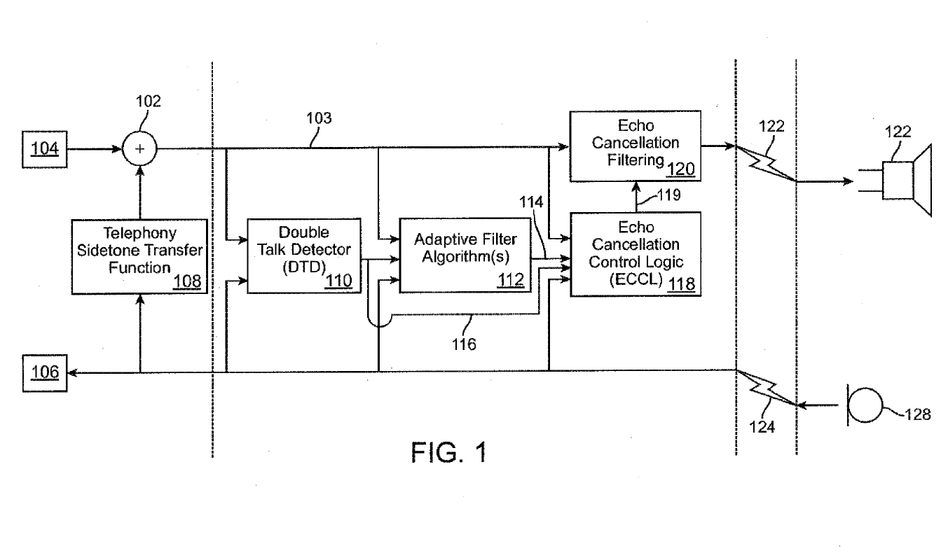

FIG. 1 illustrates a method or a system 100 in some embodiments for processing feedback signals in a telephony system.

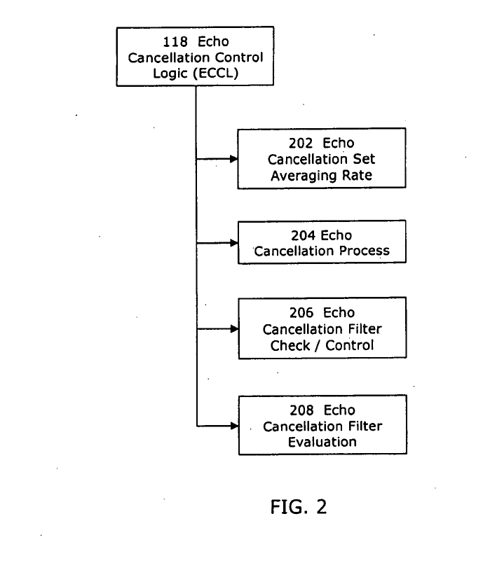

FIG. 2 illustrates more details of the echo cancellation control logic module of the method or the system 100 in some embodiments for processing feedback signals in a telephony system.

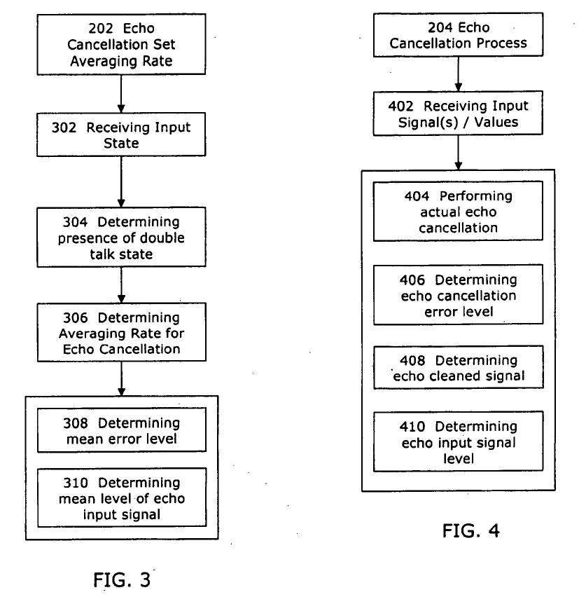

FIG. 3 illustrates more details of the echo cancellation set averaging module of the method or the system 100 in some embodiments for processing feedback signals in a telephony system.

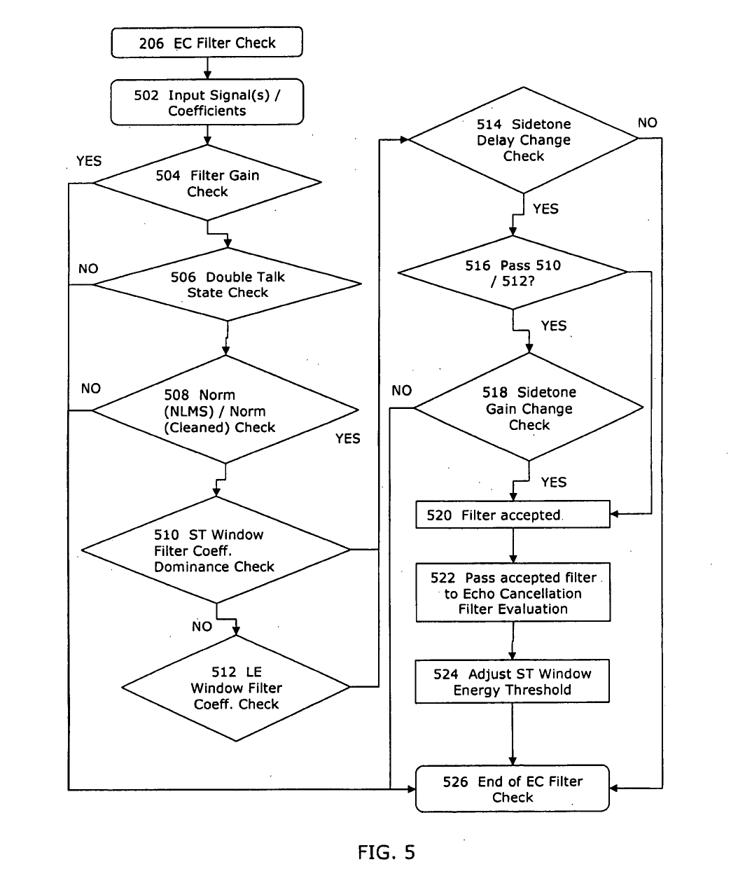

FIG. 4 illustrates more details of the echo cancellation process module of the method or the system 100 in some embodiments for processing feedback signals in a telephony system.

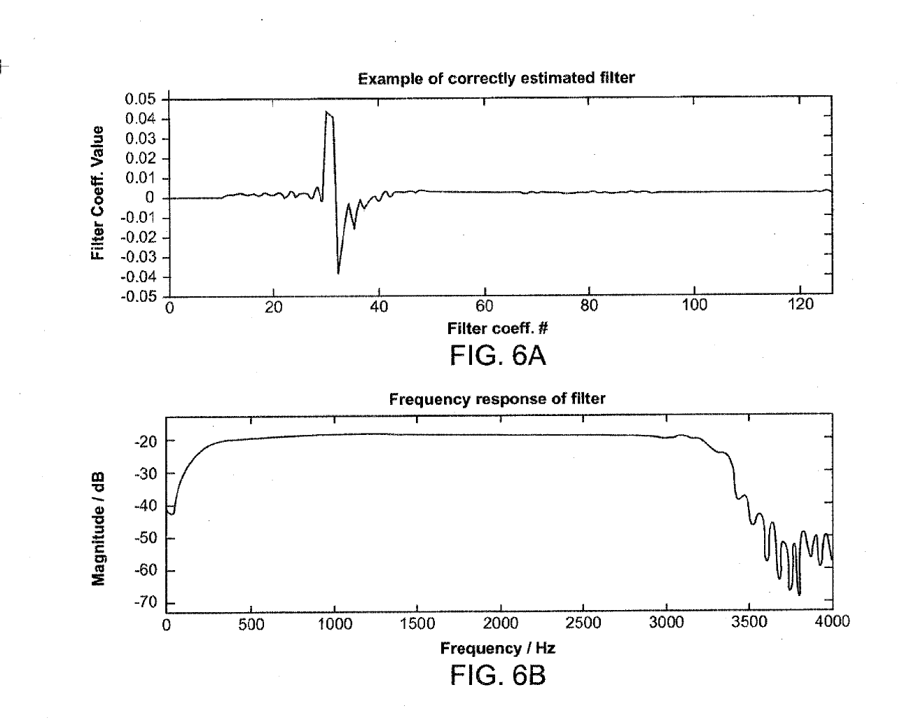

FIG. 5 illustrates more details of the echo cancellation filter check/control module of the method or the system 100 in some embodiments for processing feedback signals in a telephony system.

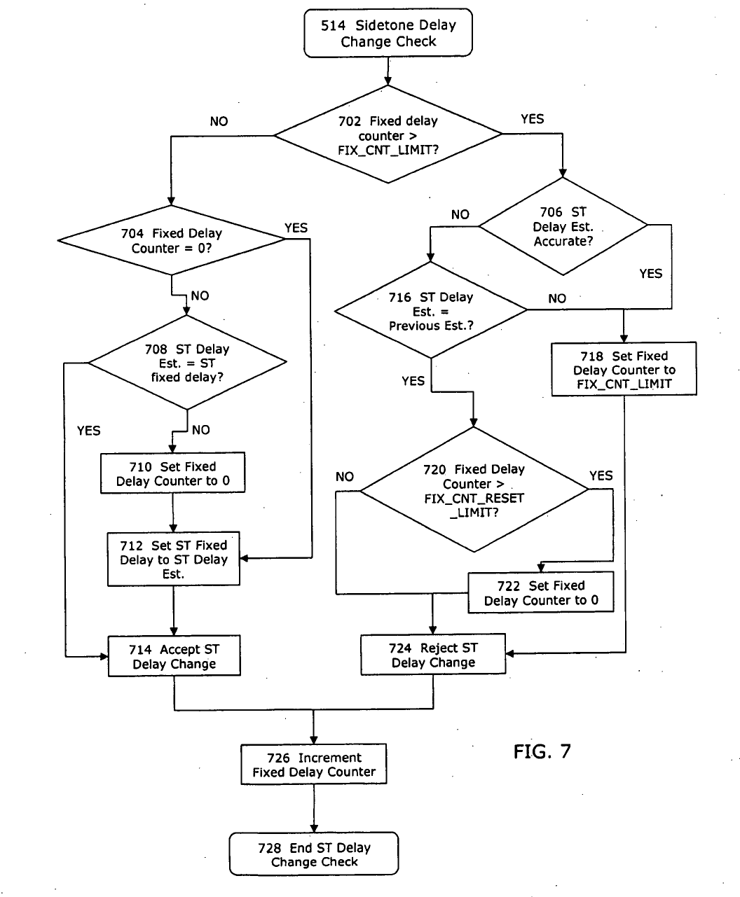

FIG. 6A illustrates a relationship between the filter coefficient number and the values of the filter coefficients of the method or the system 100 in some embodiments for processing feedback signals in a telephony system.

FIG. 6B illustrates the frequency response of a correctly estimated filter of the method or the system 100 in some embodiments for processing feedback signals in a telephony system.

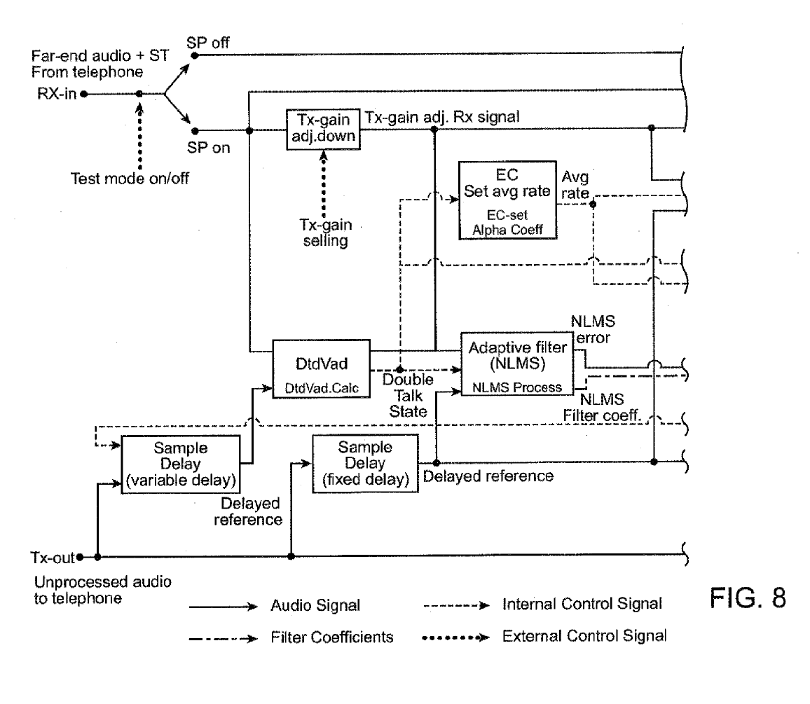

FIG. 7 illustrates more details of the sidetone delay change check module.

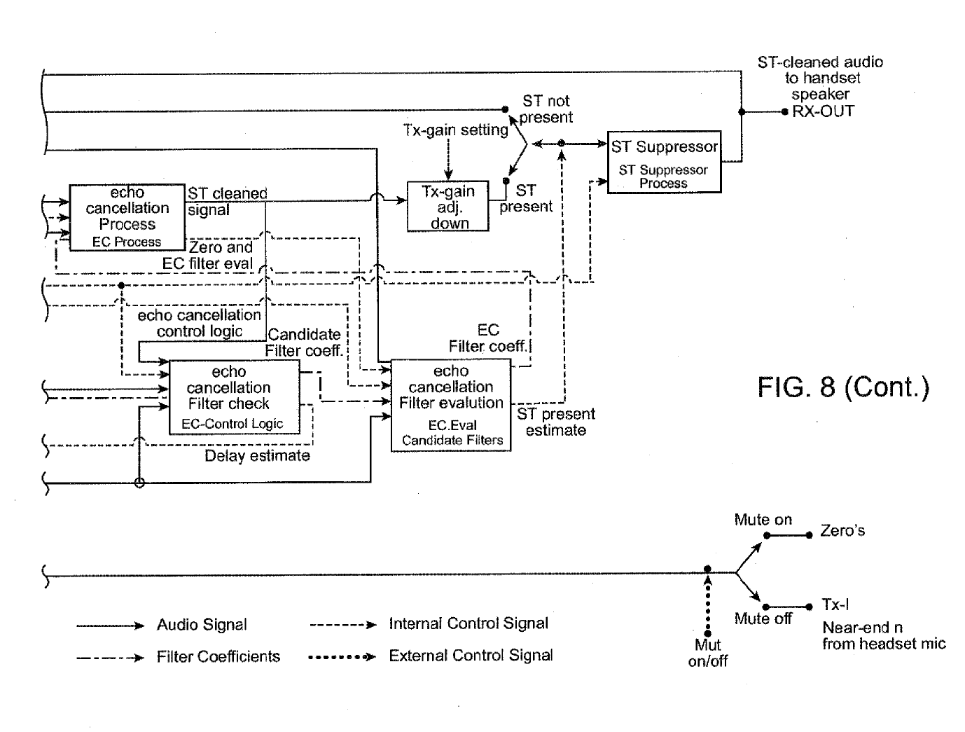

FIG. 8 illustrates a signal flow/system diagram of the method or apparatus for processing communication signals in a telephony system.

### DETAILED DESCRIPTION OF THE EMBODIMENTS

A detailed description of one or more examples is provided below along with accompanying figures. The detailed description is provided in connection with such examples, but is not limited to any such particular examples. Numerous specific details are set forth in the following description in order to provide a thorough understanding of various embodiments of the subject matters disclosed herein. These specific details are provided for illustrative purposes and the described techniques may be practiced according to the claims without some or all of these specific details. For example, some embodiments described below refer to various methods or systems for implementing the incremental placement of standard cells or instances of standard cells for illustrative purposes and thus do not intend to limit the application of the embodiments or equivalents thereof to placement of standard cells or of instances of standard cells and should not be limited as such. For the purpose of clarity, technical material that is known in the technical fields related to the examples has not been described in detail to avoid unnecessarily obscuring the description.

It is an object of various embodiments to devise a method or a system for properly processing sidetone by utilizing a sidetone echo canceller (SEC) or a sidetone echo suppressor (SES) for a communication or telecommunication device or equipment.

It is also an object of some embodiments to develop a method and a system of sidetone echo processor which comprises estimating the sidetone transfer function and further processing the estimated sidetone with respect to the input signal before sending the processed output signal to the output device such as a headset, a handset, or a loudspeaker to cause the sidetone effects to be properly processed.

In some embodiments, the method or the system comprises a double talk detector (DTD) which is configured to enable the determination a possible communication context which the communication device or equipment is currently in. In some embodiments, the possible communication context comprises a silence context, a transmission (TX) single talk context, a reception (RX) context, or a double talk context. In some embodiments where the double talk detector is configured to enable the determination of the current context, the adaptive filter(s) of the method or the system may then be adapting during transmission single talk. In some embodiments, the double talk detector and/or the adaptive filter(s) may be implemented in the form of software, hardware, or a combination of software and hardware such as an embedded system or an application specific integrated circuit (ASIC). In some embodiments, the double talk detector and/or the adaptive filter(s) may be implemented using a processor comprising a general purpose processor such as a central processing unit or an audio processor, a specialized processor such as a digital signal processor, or other similar electronic circuitry.

In various embodiments, the method or the system comprises an echo cancellation control logic module. In some embodiments, the echo cancellation control logic (ECCL) module is configured to accept, discard, and/or evaluate the filter(s) produced by at least a portion of the adaptive filter(s) using certain predetermined or dynamically determined criteria and passing the filter(s) on the an echo cancelling filter which produces the actual echo cancelled output signal set to, for example, the headset speaker. The echo cancellation control logic module may be implemented in the form of software, hardware, or a combination of software and hardware such as an embedded system or an application specific integrated circuit (ASIC). In some embodiments, the echo cancellation control logic module comprises a filter control portion. In some embodiments, the echo cancellation control logic further comprises a filter evaluation portion. In some embodiments, the echo cancellation control logic module may be implemented using a processor comprising a general purpose processor such as a central processing unit or an audio processor, a specialized processor such as a digital signal processor, or other similar electronic circuitry.

In some embodiments, the echo cancellation control logic module is configured to be completely or partly independent of the double talk detector. In some embodiments, the echo cancellation control logic module is configured to be function without a double talk detector.

It is also an object of some embodiments to perform the estimation of a sidetone transfer function (STF) at a sufficiently fast rate or within a sufficiently short time during the first use of the method or system. It is also an object of some embodiments to enable the reuse of a sidetone transfer function from one transmission event to another (e.g., the reuse of a STF from one telephone call to another telephone call) even though the transmission delay may be different between these two transmission events. It is also an object of some embodiments to enable the adaptation to changes in the sidetone gain or changes in the sidetone transfer function.

It is also an object of some embodiments to provide a more robust method and system for double talk or double talk like scenarios such as a scenario where there exists constant far-end noise during conversation or communication. It is also an object of some embodiments to provide the ability to reject filters which may lead to worse echo cancellation performance while accepting filters which may lead to better echo cancellation performance. It is also an object of some embodiments to provide a method and a system to cancel out a possible second echo such as a line echo which may lie within the range of the chosen filter length. It is also an object of some embodiments to give precise and/or stable indications of whether or not a sidetone is present and thereby skip part or all of the sidetone echo canceller (SEC) or the sidetone echo suppressor (SES) where a sidetone is determined not to be present.

Referring to FIG. 1 which illustrates a method or a system 100 in some embodiments for processing feedback signals in a telephony system.

In some embodiments, the method or system 100 of FIG. 1 comprises a near end telephony or communication device such as a telephone 102. The near end telephony or communication device receives input or incoming signals transmitted from a far end telephony or communication device 104. On the other hand, the far end telephony or communication device may also receive signals transmitted from the method or system 100 at 106. In one embodiment, the signals received at the far end telephony or communication device from the method or system 100 constitutes the near end reference signal.

The telephony or communication device or equipment may further comprise a telephony sidetone transfer function module 108. In one embodiment, the telephony sidetone transfer function module is configured to represent a relation between the input signal(s) and the output signal(s) of the method or system 100. In some embodiments, the method or system 100 is configured to be a linear time-invariant system to which the sidetone transfer function module 108 applies. In some other embodiments, the method or system 100 to which the sidetone transfer function module 108 applies constitutes a continuous-time or non-linear relation between the input and the output of the method or system 100. In some other embodiments where the method or system 100 is directed at a discrete system, the sidetone transfer function module 108 may be implemented using a pulse-transfer function such as a Z transform. Note that in various embodiments, the sidetone transfer function module may be implemented in software, hardware, or a combination of software and hardware such as an embedded system or an application specific integrated circuit (ASIC). In some embodiments, the sidetone transfer function module may be implemented using a processor comprising a general purpose processor such as a central processing unit or an audio processor, a specialized processor such as a digital signal processor, or other similar electronic circuitry. Note also that the sidetone transfer function module 108 may be implemented as part of the telephony or communication device 102 in some embodiments. In some other embodiments, the sidetone transfer function module 108 may be implemented in other portion of the system or method 100.

In some embodiments, the method or system 100 may further comprise the double talk detector (DTD) module 110. In some embodiments, the double talk detector module 110 is configured to enable the determination a possible communication context which the communication device or equipment is currently in. In some embodiments, the possible communication context comprises a silence context, a transmission (TX) single talk context, a reception (RX) context, or a double talk context. The double talk detector module 110 may determine the telephony or communication device is in a silence context when, in one embodiment, the double talk detector module 110 determines there is silence at both the input device of the near end and the far end telephony or communication devices. The double talk detector module 110 may also determine the telephony or communication device to be in a silence context when the double talk detector module 110 determines that the input and output signals are below certain threshold(s) for a predetermined period of time. The double talk detector module 110 may also determine the telephony or communication device to be in a silence context when the double talk detector module 110 determines that the changes or variations in the input and output signals are below certain threshold(s) for a predetermined period of time.

In some embodiments, the double talk detector module 110 may also determine the telephony or communication device to be in a transmission (TX) single talk context when the double talk detector module 110 identifies signals about a first threshold at the input portion of the near-end telephony or communication device but silence or signals below the first or a second threshold from the far end telephony or communication device. In some embodiments, the first and the second thresholds may be adjusted or calibrated in a way known to one skilled in the art so as to enable normal communication over the telephony or communication system.

In some embodiments, the double talk detector module 110 may also determine the telephony or communication device to be in a reception (RX) single talk context when the double talk detector module 110 identifies silence or signals below a first threshold at the input portion of the near-end telephony or communication device but signals above the first or a second threshold from the far end telephony or communication device. In some embodiments, the first and the second thresholds may be adjusted or calibrated in a way known to one skilled in the art so as to enable normal communication over the telephony or communication system.

In some embodiments, the double talk detector module 110 may also determine the telephony or communication device to be in a double talk context when the double talk detector module 110 identifies signals above a first threshold from both the input portion of the near-end telephony or communication device and the far-end telephony or communication device. In some embodiments, the first and the second thresholds may be adjusted or calibrated in a way known to one skilled in the art so as to enable normal communication over the telephony or communication system. Where the double talk detector module 110 determines the telephony or communication device to be in a double talk context, the method or the system may forward the signal(s) directly to module 118 via 116 and bypass module 112 in some embodiments.

In some embodiments where the double talk detector module 110 is configured to enable the determination of the current communication context, the adaptive filter(s) of the method or the system may then be adapting during transmission single talk. In some embodiments, the double talk detector module 110 does not produce a false detection of transmission single talk. In some embodiments, the double talk detector module 110 detects sufficient number of occasions when the communication or telephony system is in a transmission single talk context so as to enable a sufficiently fast adaptation of the adaptive filters (see more discussion for adaptive filters 112 below.) It is well known for one of ordinary skills in the art to know how often the method or the system 100 needs to detect the transmission single talk context in order to achieve a sufficiently fast adaptation of the adaptive filter(s).

In some embodiment, the double talk detector module 110 is optional. In some embodiments, the method and the system 100 operates as it is intended or designed without the double talk detector module 110. In various embodiments comprising the double talk detector module 110, the double talk detector module 110 and/or the adaptive filter(s) may be implemented in the form of software, hardware, or a combination of software and hardware such as an embedded system or an application specific integrated circuit (ASIC). In some embodiments, the double talk detector module and/or the adaptive filter(s) may be implemented using a processor comprising a general purpose processor such as a central processing unit or an audio processor, a specialized processor such as a digital signal processor, or other similar electronic circuitry.

Referring back to FIG. 1. The method or system may further comprise an adaptive filter identification module 112. Note that the adaptive filter identification module 112 may be implemented in the form of software, hardware, or a combination of software and hardware such as an embedded system or an application specific integrated circuit (ASIC). In some embodiments, the adaptive filter identification module may be implemented using a processor comprising a general purpose processor such as a central processing unit or an audio processor, a specialized processor such as a digital signal processor, or other similar electronic circuitry. In some embodiments, the adaptive filter identification module identifies or determines whether a filter may be used for subsequent echo cancellation or suppression which is to be described in more details in subsequent sections.

In some embodiments, the adaptive filter identification module comprises a process to determine one or more filter coefficients or coefficient vectors which relate to producing relatively small errors in the signals (such as a least mean squares of the error signals) by minimizing or optimizing certain cost function. Various methods or approaches, such as the least mean squares (LMS) method, a normalized least mean squares (NLMS) method, a general stochastic gradient descent method, a general optimization method, or a back-propagation method, may be used for the adaptive filter identification module 112. For example, in one embodiment where a stochastic gradient descent method is used in the adaptive filter identification module 112, the module 112 may approximate the gradient of a cost or an error function by evaluating only one or a few signals and then adjust the filter coefficient(s) or coefficient vector(s) by an amount proportional to this approximate gradient of the cost function or the error function. Further details of the method or system to determine the filter coefficient(s) of the adaptive filter(s) are known to one of ordinary skills in the art and will not be repeated here. Once the adaptive filter identification module 112 identifies or determines an adaptive filter, the identified or determined adaptive filter 114 is passed on to the next module 118. In some embodiments, the method and the apparatus may store the filter coefficient(s) or filter coefficient vector(s) in a memory device such as but not limited to volatile or non-volatile memory such as random access memory including static random access memory (SRAM), dynamic random access memory (DRMA), and synchronous random access memory (SDRAM), flash memory, electrically erasable programmable read only memory (EEPROM), or other solid-state storage devices.

In some embodiments whether a digital filter may be needed for the method or system 100, the adaptive filter comprises a finite impulse response (FIR) filter. An FIR filter is one whose response to an input (e.g., a Kronecker delta input) is finite because it settles to zero in a finite number of sample intervals. The output of an FIR filter is the sum of a finite number of finite multiples of the input values.

Referring back to FIG. 1. The method or the system 100 may further comprise an echo cancellation control logic (ECCL) module 118. Note that the echo cancellation control logic module 118 may be implemented in the form of software, hardware, or a combination of software and hardware such as an embedded system or an application specific integrated circuit (ASIC). In some embodiments, the echo cancellation control logic module may be implemented using a processor comprising a general purpose processor such as a central processing unit or an audio processor, a specialized processor such as a digital signal processor, or other similar electronic circuitry.

In some embodiments, the echo cancellation control logic (ECCL) module 118 evaluates the filters identified or determined by adaptive filter identification module 112 and determines whether this identified adaptive filter may be used or may be discarded. If the echo cancellation control logic (ECCL) module 118 determines that the current adaptive filter may be used, the module 118 passes the filter on to the echo cancellation filtering module 120 which will be described in more details below. In some embodiments where the echo cancellation control logic (ECCL) module 118 determines that the current filter that was passed on from module 112 may be discarded, either echo cancellation filtering module 120 by defaults continues to use its current filter or the module 118 instructs the echo cancellation filtering module 120 to continue to use its current filter.

In some embodiments, the echo cancellation control logic module 118 may send a message to module 112 to indicate that the filter passed from module 112 has been discarded. In some other embodiments, the echo cancellation control logic module 118 may request a new filter from module 112 for further evaluation. More details about the echo cancellation control logic module 118 are described in the following sections.

Once the echo cancellation control logic module 118 evaluates the filter and determines that the filter may be used for echo cancellation at the echo processing module 120, the echo processing module 120 then performs its function to produce the actual echo cancelled output signal in some embodiments. Module 120 may further transmit the echo cancelled output signal to an output device via a wireless link 122 to the near-end output device such as a headset or a speaker in some embodiments. Note that in some embodiments, there may exist some delay in the wireless links 122 and 124. Also note that in some embodiments, the signal(s) received at the near-end input device 128 may be used as reference signals which are sent to modules 108, 110, 112, and 118. More details about the use of near-end reference signals will be described in the following sections.

Referring to FIG. 2 which illustrates more details of the echo cancellation control logic module 118. In some embodiments, the echo cancellation control logic module 118 comprises an echo cancellation set averaging rate module 202. In addition or in the alternative, the echo cancellation control logic module 118 may comprise an echo cancellation process module 204. In addition or in the alternative, the echo cancellation control logic module 118 may comprise an echo cancellation filter check/control module 206. In addition or in the alternative, the echo cancellation control logic module 118 may comprise an echo cancellation filter evaluation module 208. Each of the modules of 202, 204, 206, and 208 will be described in more details in the following sections.

Referring to FIG. 3 which illustrates more details of the echo cancellation set averaging module 202. In some embodiments, the echo cancellation set averaging module 202 serves the purpose of adjusting the averaging speed when determining the mean error and mean input signal levels. In some embodiments, the echo cancellation set averaging module 202 may be implemented in the form of software, hardware, or a combination of software and hardware such as an embedded system or an application specific integrated circuit (ASIC). In some embodiments, the echo cancellation set averaging module may be implemented using a processor comprising a general purpose processor such as a central processing unit or an audio processor, a specialized processor such as a digital signal processor, or other similar electronic circuitry.

In some embodiments, the echo cancellation set averaging module 202 receives an input state at 302. In some embodiments where the method or the system 100 comprises the double talk detector (DTD) module 110, the input state comprises the double talk context determined by the double talk detector module 110. In these embodiments, the double talk context represents the state determined for the current block. The echo cancellation set averaging module 202 may further determine whether the communication or telephony device is currently within a double talk context or in a double talk state at 304. At 306, the echo cancellation set averaging module 202 may determine an averaging rate or speed for echo cancellation. In some embodiments, the echo cancellation set averaging module 202 may determine the presence of a double talk context or double talk state at 304 based on the input from the double detector module 110 and then determine an averaging rate or averaging speed for echo cancellation or echo suppression at 306. In other embodiments where the method or the system 100 does not comprise the double talk detector module 110, the echo cancellation set averaging module 202 may determine a constant averaging rate or averaging speed for echo cancellation or suppression.

In some embodiments, the echo cancellation set averaging module 202 may then determine the mean error level (MEL) at 308. In some embodiments, the mean error level may be determined by using the following equation:

MEL_{f}(k)=α·MEL_{f}(k−1)+(1−α)·EL_{f}(k), (1)

where the subscript f denotes the current filter being evaluated, k denotes the block number, EL_{f}(k) denotes the echo cancellation error level using the current filter fin the current block k, and a denotes the coefficient representing the averaging rate or averaging speed. In some embodiments, EL_{f}(k) may be determined by using Eq. (3) described in later sections.

In some embodiments, the echo cancellation set averaging module 202 determines the mean level of the echo input signal at 310 by using the coefficient α and the following equation:

ML_{EI}(k)=α·ML_{EI}(k−1)+(1−α)·L_{EI}(k), (2)

where the subscript EI denotes the echo input signal (combined far-end and sidetone signal), and L_{EI}(k) denotes the level of the echo input signal in the current block. In some embodiments, L_{EI}(k) may be determined by using Eq. (4) described in later sections.

In some embodiments, the α-coefficient may be chosen or determined from the range between zero and one, inclusive. In some embodiments where the value for the α-coefficient is chosen or determined to be closer to one, the current level exerts less influence on the mean level of the echo input signal. In other embodiments where the value for the α-coefficient is chosen or determined to be closer to zero, the current level exerts greater influence on the mean level of the echo input signal.

Referring to FIG. 4 which illustrates more details of the echo cancellation process module 204. Note that the echo cancellation process module 204 may be implemented in software, hardware, or a combination of software and hardware such as an embedded system or an application specific integrated circuit (ASIC). In some embodiments, the echo cancellation process module may be implemented using a processor comprising a general purpose processor such as a central processing unit or an audio processor, a specialized processor such as a digital signal processor, or other similar electronic circuitry. In some embodiments, the echo cancellation process module 204 performs the actual echo cancellation or suppression. In addition or in the alternative, the echo cancellation process module 204 may also determine L_{EI}(k) and EL_{f}(k) which are used, in some embodiments, in the echo cancellation set averaging rate module 202.

In some embodiments, the echo cancellation process module 204 receives signal(s) and/or values as input at 402. In one embodiment, the input comprises the echo input signal which constitutes the combined far-end and sidetone signal. In addition or in the alternative, the input comprises a reference signal which constitutes a delayed version of the headset microphone signal. In addition or in the alternative, the input comprises the averaging rate or averaging speed which is used in the determination of the meal error level for the current filter and mean level of the echo input signal(s). In addition or in the alternative, the input comprises the echo cleaned signal which constitutes the echo input signal cleaned for echo using the current filter. In addition or in the alternative, the input comprises the mean error level and/or the mean level for the echo input signal of the current filter.

In some embodiments, the echo cancellation process module 204 may perform actual echo cancellation using the current filter 402. In addition, the echo cancellation process module 204 may further determine the echo cancellation error level at 406. In addition or in the alternative, the echo cancellation process module 204 may also determine the echo input signal level and/or the echo cleaned at 408. In addition or in the alternative, the echo cancellation process module 204 may determine the echo input signal for one or more blocks at 410.

In some embodiments, the echo cancellation error level for block k at 406 is determined by using the following equation:

$${EL}_{EC} ( k ) = {\sum }_{n = 0}^{N - 1} \vert {S}_{cleaned , EC} ( n ) \vert , \qquad ( 3 )$$

where S_{cleaned,EC}(n) denotes the n^{th} sample of the echo cleaned input signal using the current echo cancellation filter, and N denotes the block size. In one embodiment, N is 32.

In some embodiments, the echo cleaned signal may be determined by subtracting the filtered output of the reference signal (e.g., the headset microphone input signal) from the echo input signal by using the following equation:

$${S}_{cleaned , EC} = {S}_{EI} ( n ) - {\hat{S}}_{EC} ( n ) = {S}_{EI} ( n ) - {\sum }_{m = 0}^{M - 1} {b}_{m} \cdot {S}_{ref} ( n - m ) , \qquad ( 4 )$$

where S_{EI}(n) denotes the echo input signal sample n, Ŝ_{EC}(n) denotes the estimated echo signal sample n determined using the current echo cancellation filter, bₘ denotes the m^{th} filter coefficient(s) of the EC filter, S_{ref}(n−m) denotes the (n−m)^{th} sample of the delayed reference signal due to, for example, the delay in the wireless link(s) 122 and/or 124.

In some embodiments, the echo cancellation process module 204 may also determine the level of the echo input signal for block k at 408 using the following equation:

$${L}_{EI} ( k ) = {\sum }_{n = 0}^{N - 1} \vert {S}_{EI} ( n ) \vert , \qquad ( 5 )$$

Referring to FIG. 5 which illustrates more details of the echo cancellation filter check/control module 206. In some embodiments, the echo cancellation filter check/control module 206 sorts out, based at least in part upon one or more criteria, filters and determine whether a filter which is currently being evaluated performs better or worse than a previously accepted filter does in terms of echo cancellation or suppression. In some embodiments where the new filter that is currently being evaluated performs better than the previously accepted filter, the new filter is accepted as a new candidate filter, and the previously accepted filter may be discarded. In some embodiments, the echo cancellation filter check/control module 206 may be based upon prior knowledge of a correctly estimated echo cancellation filter. For example, FIGS. 6A and 6B illustrate an example of a correctly estimated filter where FIG. 6A illustrates a relationship between the filter coefficient number and the values of the filter coefficients, and FIG. 6B illustrates the frequency response of a correctly estimated filter.

Referring back to FIG. 5. The echo cancellation filter check/control module 206 identifies signal(s) and/or filter coefficients or coefficient vectors as an input at 502. In one embodiment, the input comprises an echo cleaned signal which constitutes a signal cleaned with the current echo cancellation filter. In addition or in the alternative, the input comprises a double talk state which constitutes the double state determined for the current block. In addition or in the alternative, the input comprises a error caused by the adaptive filter process module 112 which constitutes, for example, the normalized least mean squares error signal in some embodiments which utilize the normalized least mean squares process in the adaptive filter process module 112. In addition or in the alternative, the input comprises a reference signal which constitutes the delayed version of the near-end input signal (e.g., the headset microphone). In addition or in the alternative, the input comprises one or more candidate filter coefficients which constitute the filter coefficient(s) or filter coefficient vector(s) in embodiments where the filter accepted the filter coefficient(s) or filter coefficient vector(s) are passed on to the echo cancellation filter evaluation.

In some embodiments, the echo cancellation filter check/control module 206 may perform filter gain check at 504 to determine whether the filter gain for the filter that is currently being checked exceeds a threshold. Where the filter gain check at 504 determines that the filter gain exceeds the threshold, the filter may be discarded in some embodiments. In some embodiments, the filter gain may be determined as the norm of the filter coefficients. In one embodiment, a filter whose gain exceeds a certain threshold may be discarded because the filter, when used in the echo cancellation or suppression, may result in unpleasantly loud and distorted echo signals which are to be sent to the near-end output device (such as a headset speaker.) In one embodiment, the threshold may be set to 2⁻². In some other embodiments where the filter gain is determined to be below a second threshold, the filter may be discarded to reduce the number of filter coefficients. In one embodiment, the second threshold may be set to 2⁻¹⁵.

In some embodiments, the echo cancellation filter check/control module 206 may perform double talk state check at 506. In some embodiments, the double talk state check at 506 is to ensure that a filter may be accepted where the communication context is estimated to be transmission single talk context.

In some embodiments, the echo cancellation filter check/control module 206 may evaluate the norm of the error of the adaptive filter process against the norm of the echo input signal at 508. For example, in one embodiment, the echo cancellation filter check/control module 206 may evaluate the norm of the normalized least mean squares method in the adaptive filter process against the norm of the echo input signal. In some embodiments, this ensures that filter that is currently being evaluated exhibits a better instantaneous performance than the previously accepted filter does. In addition or in the alternative, the echo cancellation filter check/control module 206 may further determine whether the filter that is currently being evaluated exhibits a better overall performance than the previously accepted filter in some embodiments. In one embodiment, this overall performance check may be determined by the following equation:

Norm(e_{NLMS})<Norm(S_{cleaned,EC}), (6)

In some embodiments, filters which pass the requirements of Eq. (6) proceed to the remaining checks as described in the following section.

In some embodiments, the echo cancellation filter check/control module 206 may perform the sidetone window filter coefficients dominance check at 510. A sidetone window here refers to a relatively narrow area where the majority of the active filter coefficients are placed within the relatively narrow area. A sidetone peak is defined as the index of the maximum absolute filter coefficient. A sidetone window may be determined to be a fixed size window of certain size around a sidetone peak. In some embodiments, the sidetone window is determined to be of the size 32, and the sidetone window may be determined by using the following equation in these embodiments:

ST_{window}=[/Index(max(|b|)−7;Index(max(|b|)+24], (7)

where b is the filter coefficients passed on from the optimization method of the adaptive filter process (e.g., normalized least mean square). Where the upper or lower part of the sidetone window is outside the filter coefficients, it is truncated to the maximum/minimum filter coefficient.

In some embodiments, in order for a filter to pass the sidetone window filter coefficients dominance check at 510, the power of the filter within the sidetone window, P_{ST}, may be required to exceed the power of the remainder of the filter coefficients outside the sidetone window, P_{REM}. In some embodiments, a continuously adjusting threshold, Thr_{ST}, may control how much P_{ST} has to be larger than P_{REM}. In some embodiments, the power of the filter coefficients within the sidetone window may be determined by the following equation:

$${P}_{ST} = {\sum }_{m = min ( ST\_window )}^{max ( ST\_window )} {b}_{m}^{2} , \qquad ( 8 )$$

In some embodiments, the power of the filter coefficients outside the sidetone window may be determined by the following equation:

$${P}_{REM} = [ {\sum }_{m = 0}^{M - 1} {b}_{m}^{2} ] - {P}_{ST} , \qquad ( 9 )$$

In these embodiments, the sidetone window check may be expressed as follows:

P_{REM}<Thr_{ST}·P_{ST}, (10)

In some embodiments where a filter passes the sidetone window check, the echo cancellation filter check/control module 206 may further perform the line echo (LE) window filter coefficient check at 512. In some embodiments, the LE window filter coefficient check at 512 makes it possible for the echo cancellation control logic module 118 to accept filters containing a second echo such as a line echo. In these embodiments, the second echo may occur on certain types of telephony or communication systems and may result in an echo being correctly estimated in the filter coefficients similar to the echo as see in the sidetone window filter coefficients but with less amplitude. In these embodiments, such a filter may not be accepted by the sidetone window filter coefficient dominance check at 510 but may be accepted by the LE window filter coefficient check at 512.

In some embodiments, the line echo window may be similarly defined as the sidetone window using the peak filter coefficient outside the sidetone window. In one embodiment, the LE window is determined to be of size 20, and the LE window may be determined by the following equation:

LE_{window}=[Index(max(|b_{REM}|)−7;Index(max(|b_{REM}|)+12], (11)

where b_{REM} denotes the filter coefficients outside the sidetone window.

A power value for the remaining filter coefficients may then be determined by the following equation in this embodiment:

$${P}_{REM , LE} = {P}_{REM} - [ {\sum }_{m = min ( LE\_window )}^{max ( LE\_window )} {b}_{m}^{2} ] , \qquad ( 12 )$$

In this embodiment, the LE window filter coefficient check may then be expressed as follows:

P_{REM,LE}<Thr_{ST}·P_{ST}, (13)

After performing the line echo (LE) window filter coefficient check at 512, a flag may be set to indicate whether the filter has been accepted or rejected by the sidetone window and/or the LE window check in some embodiments.

In some embodiments, the echo cancellation filter check/control module 206 may perform a sidetone delay change check at 514. In some embodiments, the sidetone delay change check at 514 is performed to ensure that a filter is not accepted where the estimated sidetone delay changes more than a given limit. In some embodiments, the sidetone delay change is determined as the index of the sidetone peak coefficient relative to the index of the first filter coefficient. The sidetone delay change check at 514 may then be expressed as follows in some embodiments:

|ST_{delay,fixed}−ST_{delay,estimate}|≦ST_{delay,threshold}, (14)

where ST_{delay,fixed} denotes the sidetone delay considered to be the fixed/correct sidetone delay, ST_{delay,estimate} denotes the sidetone delay estimated using the current filter. In one embodiment, ST_{delay,threshold} may be set to zero (0).

In some embodiments, the fixed/correct sidetone delay may be determined by counting the number of the following filters which have an identical sidetone delay estimate. More details about the sidetone delay change check 514 are described in the following sections for FIG. 7.

Referring to FIG. 7 which illustrates more details of the sidetone delay change check module of 514. In some embodiments, the sidetone delay change check module 514 determines whether the fixed delay counter is greater a fixed delay counter limit, FIX_CNT_LIMIT, at 702. In some embodiments where the sidetone delay change check module 514 determines that the fixed delay counter is greater than the fixed delay counter limit, the sidetone delay change check module 514 determines whether the fixed delay counter is zero (0) at 704. In some embodiments where the sidetone delay change check module 514 determines that the fixed delay counter is zero at 704, the sidetone delay change check module 514 accepts the sidetone delay change at 714.

In some embodiments where the sidetone delay change check module 514 determines the sidetone delay change is not zero, the sidetone delay change check module 514 determines whether the sidetone delay is the sidetone fixed delay at 708. In some embodiments where the sidetone delay change check module 514 determines that the sidetone delay is equal to the sidetone fixed delay, the sidetone delay change check module 514 accepts the sidetone delay change at 714. In some embodiments where the sidetone delay change check module 514 determines that the sidetone delay is not equal to the sidetone fixed delay at 708, the sidetone delay change check module 514 sets the fixed delay counter to zero at 710. At 712, the sidetone delay change check module 514 then sets the sidetone fixed delay to the sidetone delay estimate and accepts the sidetone delay change at 714 in some embodiments where the sidetone delay change check module 514 determines that the sidetone delay is not equal to the sidetone fixed delay at 708.

In some embodiments where the sidetone delay change check module 514 determines that the fixed delay counter is greater than the fixed delay counter limit at 702, the sidetone delay change check module 514 determines whether a sidetone delay estimate is sufficiently accurate based on, for example, a threshold for the deviation of the sidetone delay estimate at 706. In some embodiments where the sidetone delay change check module 514 determines that the sidetone delay estimate is not sufficiently accurate, the sidetone delay change check module 514 further determines whether the first delay estimate is equal to one or more previous sidetone delay estimates at 716.

In some embodiments where the sidetone delay change check module 514 determines that the sidetone delay estimate is not equal to a previous sidetone delay estimate, the sidetone delay change check module 514 proceeds to 718 to set the fixed delay counter to the fixed delay counter limit. In these embodiments where the sidetone delay estimate is determined not to be equal to the previous sidetone delay estimate, the sidetone delay change check module 514 then rejects the sidetone delay change at 724.

In some embodiments where the sidetone delay change check module 514 determines that the sidetone delay estimate is equal to a previous sidetone delay estimate at 716, the sidetone delay change check module 514 proceeds to 720 to determine whether the fixed delay counter is greater than a fixed delay counter reset limit. In some embodiments where the sidetone delay change check module 514 determines that the fixed delay counter is greater than the fixed delay counter reset limit at 720, the sidetone delay change check module 514 proceeds to 722 and sets the fixed delay counter to zero. In these embodiments where the sidetone delay change check module 514 determines that the fixed delay counter is greater than the fixed delay counter reset limit at 720, the sidetone delay change check module 514 then proceeds to 724 to reject the sidetone delay change. In some other embodiments where the sidetone delay change check module 514 determines that the fixed delay counter is not greater than the fixed delay counter reset limit at 720, the sidetone delay change check module 514 proceeds to 724 and rejects the sidetone delay change.

In various embodiments after the sidetone delay change check module 514 either accepts the sidetone delay change at 714 or rejects the sidetone delay change at 724, the sidetone delay change check module 514 then proceeds to 726 to increment the fixed delay counter, and the sidetone delay change check module 514 ends at 728.

Referring back to FIG. 5. In some embodiments, the echo cancellation filter check/control module 206 may, in addition or in the alternative, perform the sidetone gain change check at 518. In some embodiments, the sidetone gain change check at 518 is performed such that the method or the system 100 is possible to accept a filter if the sidetone gain changes. An exemplary circumstance under which sidetone gain changes occur is when the volume control of the output device of the telephony or communication system is adjusted. In some embodiments, the sidetone gain change check at 518 expects the filter to exhibit a similar shape with a different gain. In some embodiments, the filter that is currently being evaluated may be required to pass either the sidetone window filter coefficient dominance check at 510 and/or the line echo window filter coefficient check at 512. In these embodiments where the filter that is currently being evaluated fails both the check at 510 and the check 512, the filter will be discarded.

The sidetone gain change check at 518 may, in some embodiments where the normalized least mean squares (NLMS) method is used for adaptive filter process, first determine whether the sidetone gain change is sufficiently large to be considered a gain change by using the following criterion:

min(P_{ST,CAND},P_{ST,NLMS})<max((P_{ST,CAND},P_{ST,NLMS})·Thr_{ST,Gain}, (15)

where P_{ST,CAND} denotes the power of the sidetone window of the candidate filter, and P_{ST,NLMS} denotes the power of the sidetone window of the NLMS filter being checked.

In some embodiments where the filter does not pass the requirement of formula (15), the filter will be rejected. In other embodiments where the filter passes the requirement of formula (15), it will be checked to determined whether the NLMS and candidate filter are sufficiently similar within the sidetone window to consider it a pure gain change. In some embodiments, the gain difference may be determined as:

$${G}_{diff} = \sqrt{\frac{{P}_{ST , CAND}}{{P}_{ST , NLMS}}} , \qquad ( 16 )$$

In these embodiments, the similarity between the sidetone window of the two filters may be determined as follows:

E_{ST,gain}=Σ_{m=min(ST}_{_{window}}₎^{max(ST}^{_{window}}⁾|b_{m,CAND}−G_{diff}·b_{m,NLMS}|, (17)

where b_{m,CAND} is the m^{th} filter coefficient of the candidate filter and b_{m,NLMS} is the m^{th} filter coefficient of the NLMS filter to be checked.

In some embodiments, if the error or similarity value is below a fixed threshold the filters may be considered similar and are different due to gain difference. In these embodiments, the filters may be accepted even though they have been rejected by the sidetone/line echo window check. In one embodiment, the fixed threshold may be set to 0.3.

In some embodiments where the filter that is currently being checked passes the check at 518, the filter is accepted at 520, and the echo cancellation filter check module 206 passes the accepted filter to echo cancellation filter evaluation at 522. The echo cancellation filter evaluation at 522 will be described in more details in subsequent sections. In some embodiments, the echo cancellation filter check module 206 may adjust the sidetone window energy threshold at 524.

In some embodiments where a filter is accepted by 206, the threshold used in the sidetone window check and/or the line echo window check may be adjusted or decreased such that the next filter to be accepted may exhibit a noise floor outside the sidetone/line echo window lower than that of the currently accepted filter. In some embodiments, the threshold may be adjusted or decreased using the following:

Thr_{ST}=max(C_{decay}·Thr_{ST},Thr_{ST,min}), (18)

where C_{decay} denotes the decay factor used, and Thr_{ST,min} denotes the lower limit for the threshold.

In some embodiments, the echo cancellation filter check/control module 206 passes the filter coefficients on as the new candidate filter coefficients after adjusting the threshold at 524, and the module 206 terminates normally at 526.

In some embodiments, the echo cancellation filter evaluation module 208 may serve to avoid performance decrease in echo cancellation or suppression possibly due to a false filter which passes the checks performed by the echo cancellation filter check/control module 206. In some embodiments, the echo cancellation filter evaluation module 208 receives signal(s) and/or value(s) as an input. In one embodiment, the input comprises the echo input signal which constitutes the combined far-end and sidetone signal. In addition or in the alternative, the input comprises the mean error level for the current echo cancellation filter and the mean level of echo input signal. In addition or in the alternative, the input comprises α-coefficient(s) which constitutes the averaging rate or averaging speed used in the determination of the mean error level for the echo cancellation filter and the mean level of the echo input signal. In addition or in the alternative, the input comprises the candidate filter coefficient(s) which constitute the adaptive filter coefficients of a filter accepted. In addition or in the alternative, the input comprises the reference signal which constitutes the delayed version of the near-end input signal (e.g., a headset microphone signal.) In addition or in the alternative, the input comprises echo cancellation coefficients passed on to the echo cancellation process module. In addition or in the alternative, the input comprises the sidetone present estimate which constitutes a flag to indicate whether sidetone is estimated to be present or not; this input may be used for selecting either the echo cleaned signal or original echo input signal for the near-end output device (e.g., a headset speaker output.)

In some embodiments, the echo cancellation filter evaluation module 208 may determine the mean error level for at least one of the most recent candidate filter passed on from the echo cancellation filter check/control module 206, the echo cancellation filter currently in use but shifted one to the left, and the echo cancellation filter currently in use but shifted one to the right.

In some embodiments, the echo cancellation filter evaluation module 208 compares the mean error level of each filter with that of the currently used, echo cancellation filter and the level of the unmodified echo input signal. In some embodiments, the echo cancellation filter evaluation module 208 fine tune the filter evaluation such that considerable performance and passed on to the echo cancellation process by using the following formula including a threshold, Thr_{MEL}:

MEL_{f}<THr_{MEL}·MEL_{EC}, (19)

where MEL_{f} denotes the mean error level of the filter compared with the mean error level of the echo cancellation filter currently used, MEL_{EC}. Where comparing with the level of the echo input signal the same equation may be used by replacing the MEL_{f} with ML_{EI} and may also use a different threshold level.

In one embodiment, the threshold may be set to 0.7 for comparison of filter performance. In one embodiment, the threshold may be set to 0.8 for comparison with the level of the echo input. In some embodiments, where a filter satisfies the requirement of formula (19), the filter is accepted and replaces the echo cancellation filter that is currently in use.

In some embodiments where the echo input signal level may be found to satisfy formula (19), the echo cancellation filter is not replaced but rather an output flag may be used to indicate that no sidetone is present. In these embodiments, the method or system 100 may output the unmodified echo input to the near-end output device (e.g., a headset speaker) rather than the echo canceled output signal from the echo cancellation process. This will continued to the be output until the echo cancellation filter is found to have a mean error level that satisfies formula (19) when comparing with ML_{EI}.

Referring to FIG. 8 which illustrates, in some embodiments, a signal flow/system diagram of the method or apparatus for processing communication signals in a telephony or communication system. In FIG. 8, the audio signal(s), internal control signal(s), the filter coefficient(s), and the external control signal(s) are depicted with different line types and width(s) for ease of illustration and explanation. Note that FIG. 8 is presented for illustration and explanation purposes and does not intend to limit the scope of the disclosure. In some embodiments, the SampleDelay module delays the incoming signal by a fixed amount or a variable amount of samples. In some embodiments, the fixed delay SampleDelay module adjusts the delay of the reference transmission signal that are transmitted into the echoCancellation Process module, the Adaptive Filter (NLMS) module, the echoCancellation Filter Check module, and/or the echoCancellation Filter evaluation module to the sidetone delay as seen from the inside of the communication or telephony system. In some embodiments, the variable delay by the respective SampleDelay module further fine tunes the delay of the reference transmission signal going into the DtdVad module to substantially fit the sidetone delay as seen from the inside of the communication or telephony system. In some embodiments, the variable delay is an estimate based on the filter taps in the echo canceller filter.

Moreover, in some embodiments, the Double Talk Detector Voice Activity Detector (DtdVad) module estimates or determines whether the reception and reference signals are active speech signals. In one embodiment, the Double Talk Detector Voice Activity Detector (DtdVad) module estimates or determines whether the reception and references signals are active speech signals by comparing signal characteristics with one or more pre-determined pre-defined signal characteristics of noise, tone, and/or speech signals.

In some embodiments, the Double Talk Detector Voice Activity Detector (DtdVad) module uses the Vad (voice activity detector) estimates to segment the current speech scenario into one or the following five scenarios or contexts.

In some embodiments, the Double Talk Detector Voice Activity Detector (DtdVad) module segments the current speech scenario into a silence scenario or context when both the reception (Rx) signal and the reference signal are estimated or determined not to constitute active speech signals.

In some embodiments, the Double Talk Detector Voice Activity Detector (DtdVad) module segments the current speech scenario into a reception (Rx) single talk scenario or context when a reception (Rx) signal is estimated or determined to be an active speech signal, and a reference signal is estimated or determined not to constitute an active speech signal. In some embodiments, the Double Talk Detector Voice Activity Detector (DtdVad) module segments the current speech scenario into a transmission (Tx) single talk scenario or context when the reference signal is estimated or determined to constitute an active speech signal, and the reception (Rx) signal is estimated or determined to constitute an echo version of the reference signal by exhibiting or having similar characteristics. In some embodiments where the Double Talk Detector Voice Activity Detector (DtdVad) module segments the current speech scenario into a Tx single talk scenario or context when the reference signal is estimated or determined to constitute an active speech signal, and the reception (Rx) signal is estimated or determined to constitute an echo version of the reference signal by having a similar ratio with respect to the sidetone gain.

In some embodiments, the Double Talk Detector Voice Activity Detector (DtdVad) module segments the current speech scenario into a double talk scenario or context when a reception (Rx) signal and a reference signal are estimated or determined to be active speech signals. In some embodiments, the Double Talk Detector Voice Activity Detector (DtdVad) module segments the current speech scenario into a silence scenario or context when both the reception (Rx) signal and the reference signal are estimated or determined not to have similar characteristics and/or gain with respect to the estimated sidetone gain. That is, in these embodiments, the method or the system does not determine or identify a transmission (Tx) single talk scenario or context.

Furthermore, in some embodiments, the Double Talk Detector Voice Activity Detector (DtdVad) module segments the current speech scenario into a out-of-range scenario or context when the method or system receives loud or distorted signals.

In various embodiments, the output of the Double Talk Detector Voice Activity Detector (DtdVad) module is used to control the Adaptive Filter (NLMS) module, the echoCancellation Filter Evaluation module, and/or the sidetone (ST) Suppressor module. In some exemplary embodiments, the adaptation and/or requires transmission (Tx) single talk, while sidetone (ST) suppressor changes state according to the DtdVad output. In some embodiments, the sidetone (ST) suppressor module switches on a fixed amount of attenuation of the reception (Rx) signal when the scenario or context is determined or estimated to be the transmission (Tx) single talk scenario or context. In some embodiments, the attenuation is released when the scenario or context is determined to be reception (Rx) single talk. In some embodiments, all other Double Talk Detector Voice Activity Detector (DtdVad) states do not change the state of the sidetone (ST) suppressor.

In the foregoing specification, various embodiments have been described with reference to specific embodiments thereof. It will, however, be evident that various modifications and changes may be made thereto without departing from the broader spirit and scope of the disclosure herein. For example, the above-described process flows are described with reference to a particular ordering of process actions. However, the ordering of many of the described process actions may be changed without affecting the scope or operation of various embodiments or equivalents disclosed herein. The specification and drawings are, accordingly, to be regarded in an illustrative rather than restrictive sense.

1. A method for processing communication signals in a communication system, the method comprising:
identifying a first signal, in which the first signal comprises an incoming communication signal and a feedback signal;
controlling a logic for cancelling or suppressing a feedback effect based at least in part upon the first signal;
processing the first signal using an: adaptive filter based at least in part upon the first signal and a result of the act of controlling the logic for cancelling or suppressing the feedback effect; and
causing the processed first signal to be transmitted to a first output device.

2. The method of claim 1, further comprising:
identifying a communication context which the communication system is currently in.

3. The method of claim 2, in which the communication context comprises a silence context, a transmission single talk context, a reception context, or a double talk context.

4. The method of claim 1, in which the first feedback signal, comprises a sidetone signal.

5. The method of claim 3, in which the criterion comprises a determination that the communication system not in the double talk context.

6. The method of claim 1, in which the act of identifying an adaptive filter comprises:
determining a filter coefficient for the adaptive filter.

7. The method of claim 6, in which the act of determining a filter coefficient comprises optimizing a first function using an optimizing process.

8. The method of claim 7, in which the first function comprises a cost function or an error function.

9. The method of claim 7, in which the optimizing process comprises a optimization process, a back-propagation process, a normalized least mean squares process, or a stochastic method.

10. The method of claim 1, in which the filter comprises a finite response filter.

11. The method of claim 1, in which the feedback effect is caused at least in part by the feedback signal.

12. The method of claim 1, in which the act of controlling a logic comprises:
setting an averaging rate for processing the signal;
performing a cancellation or suppression process on the feedback effect;
determining whether the adaptive filter meets a second criterion; and
evaluating the adaptive filter.

13. The method of claim 12, in which the act of setting an averaging rate for processing the signal comprises:
receiving a first input;
determining whether the communication is currently in a double talk state;
determining the averaging rate for processing the feedback effect;
determining a first mean error level; and
determining a first mean level of an echo input signal.

14. The method of claim 12, in which the act of performing a cancellation or suppression process on the feedback effect comprises:
receiving a second input;
determining an error level for processing the feedback effect;
determining a second signal, in which the feedback effect is not present in the second signal; and
determining a level for the echo input signal.

15. The method of claim 12, in which the second criterion comprises:
determining whether the adaptive filter performs better for the act of processing the signal using the adaptive filter.

16. The method of claim 12, in which the second criterion comprises at least one of a filter gain check, a double talk state cheek, a sidetone window filter coefficient dominance check, a line echo window filter coefficient, a sidetone delay change check, or a sidetone change check.

17. The method of claim 12, in which the act of determining whether the adaptive filter meets the second criterion further comprises adjusting a sidetone window energy threshold.

18. The method of claim 1, in which the processed signal is transmitted, to the first output device via a wireless link.

19. The method of claim 1, further comprising:
receiving a reference signal from, a first input device.

20. The method of claim 19, in which the act of controlling the logic is based further upon the reference signal.

21. The method of claim 19, in which the act of processing the first signal is based further upon the reference signal.

22. An apparatus for processing communication signals in a communication system, the apparatus comprising:
means for identifying a first signal, in which the first signal comprises an incoming communication signal and a feedback signal;
means for controlling a logic for cancelling or suppressing a feedback effect based at least in part upon the first signal;
means for processing the first signal using an adaptive filter based at least in part upon the first signal and a result of the act of controlling a logic for cancelling or suppressing a feedback effect; and
means for causing the processed first signal to be transmitted to a first output device.

23. The apparatus of claim 22, further comprising:
means for storing a result of the means for controlling a logic, in which the means for storing the result comprises a memory device.

24. The apparatus of claim 22, further comprising:
means for identifying a communication context which the communication system is currently in.

25. The apparatus of claim 22, further comprising:
means for determining a filter coefficient for the adaptive after.

26. An system for processing communication signals in a communication system, the apparatus comprising:
a first input module configured to identify a first signal, in which the first signal comprises an incoming communication signal and a feedback signal;
an adaptive filter identification module configured to identify a filter for processing the communication signals in the communication system;
a feedback signal cancellation control logic module configured to control a logic for processing the communication signals in the communication system;
a signal processing module configured to process the first signal using the filter identified

27. The system of claim 26, further comprising:
a sidetone transfer function module configured to represent a relation between the first input signal and an output signal.

28. The system of claim 26, further comprising:
a double talk detector module configured to determine a communication context which the communication system is in.
